(19) United States
(12) Patent Application Publication
(10) Pub. No.: US 2021/0218031 A1
(43) Pub. Date: Jul. 15, 2021

(54) MODIFIED SOLID-STATE ELECTROLYTE FOR LI METAL SOLID-STATE BATTERIES

(71) Applicant: FORD GLOBAL TECHNOLOGIES, LLC, Dearborn, MI (US)

(72) Inventors: Andrew Robert DREWS, Ann Arbor, MI (US); Asma SHARAFI, Ann Arbor, MI (US)

(21) Appl. No.: 16/741,112

(22) Filed: Jan. 13, 2020

(51) Int. Cl. H01M 4/62; H01M 10/0525; H01M 2/16; H01M 10/0562; H01M 4/38

(52) U.S. Cl. CPC H01M 4/628; H01M 10/0525; H01M 2004/027; H01M 10/0562; H01M 4/382; H01M 2/1646

(57) ABSTRACT

According to one or more embodiments, a solid-state battery includes a cathode; an anode including lithium metal; and an inorganic ceramic polycrystalline separator between the cathode and anode. The separator includes grains of an ionically conductive bulk phase and grain boundaries defined between the grains, with the grain boundaries including an oxidizing agent. The oxidizing agent is configured to oxidize the lithium metal, brought into contact with the oxidizing agent via lithium metal nucleation at or dendritic growth along the grain boundaries that results from plating of the lithium metal on the anode, to form an electronically insulating phase to prevent formation of electronic conduction pathways along the grain boundaries. The oxidizing agent is further configured to partially reduce, upon oxidation of the lithium metal, to form an ionically conductive phase to facilitate ionic conduction along the grain boundaries.

### TECHNICAL FIELD

The present disclosure relates to components and structures for lithium ion batteries, and particularly to solid electrolytes in solid-state batteries.

### BACKGROUND

The large-scale adoption of low cost and high-performance electric vehicles (EVs) has led to extensive research and development of battery technologies with high energy density. Batteries based on alkali metal-ion intercalation cathodes and anodes, such as lithium ion batteries (LIB) have been widely adopted for use in EVs. Conventional LIBs using a graphite anode have a theoretical capacity of 874 mAh/cm³ which approach the practical limits for energy density, and is below the needed energy density for widespread adoption of EVs.

Consequently, lithium metal batteries have been recognized as possible high energy density batteries for EVs due to the use of a Li metal anode electrode with a high theoretical charge capacity (2046 mAh/cm³) and a low negative electrochemical potential (−3.04 V vs. a conventional hydrogen electrode). However, lithium metal batteries may form lithium dendrites during charging, and may have a low Coulombic efficiency, which have prevented the practical implementation of Li metal anodes. Lithium dendrite suppression and control can improve performance and cycle life of the battery.

A conventional approach to enable the use of a lithium metal anode is mechanically suppressing the formation of Li dendrites by employing a solid-state electrolyte (SSE) to replace a porous polymer separator and liquid electrolyte. As such, an SSE acts as a physical barrier to dendrite penetration. However, internal short circuits have been shown to still form and cause self-discharge of the battery, even for ceramic SSE cells. Some studies have suggested that an effective SSE would need to have twice the shear modulus of Li metal (4.2 GPa) to mechanically suppress Li dendrite propagation. However, studies on various SSEs with shear moduli exceeding the shear modulus of Li metal by more than this factor of 2 may show a sudden drop in polarization voltage at low current density, indicating that short circuits may have formed. In certain instances, propagation of lithium metal along the grain boundaries can be an indication of higher ionic or electronic conductivity at the grain boundaries compared to bulk phases. In this instance, electrons and Li ions may combine at locations within the bulk of the SSE, which may result in the formation and propagation of Li metal at the grain boundaries rather than exclusively at the plating side of the SSE. Thus, alternative strategies are needed to suppress and control dendrites with respect to solid-state electrolyte separators.

### SUMMARY

According to one or more embodiments, a solid-state battery includes a cathode; an anode including lithium metal; and an inorganic ceramic polycrystalline separator between the cathode and anode. The separator includes grains of an ionically conductive bulk phase and grain boundaries defined between the grains, with the grain boundaries including an oxidizing agent. The oxidizing agent is configured to oxidize the lithium metal, brought into contact with the oxidizing agent via lithium metal nucleation at or dendritic growth along the grain boundaries that results from plating of the lithium metal on the anode, to form an electronically insulating phase to prevent formation of electronic conduction pathways along the grain boundaries. The oxidizing agent is further configured to partially reduce, upon oxidation of the lithium metal, to form an ionically conductive phase to facilitate ionic conduction along the grain boundaries.

According to at least one embodiment, the oxidizing agent may be a binary metal oxide having the composition MO, MO₂, M₂O, or M₂O₃, where M is a metal, or a complex transition metal oxide. In one or more embodiments, the ionically conductive bulk phase may be LLZO, a sodium super ionic conductor (NASICON) having the formula NaM₂(PO₄)₃, where M is a cation, Li₅La₃M₂O₁₂ where M is Ta or Nb, Li₃ₓLa_{2/3-x}TiO₃ (LLTO), a lithium super ionic conductor (LiSICON) having an ionic conductivity of 1.25×10⁻¹ S/cm at 300° C., or a lithium phosphorous oxynitride (LiPON). In certain embodiments, the grain boundaries may be pores or voids within the inorganic ceramic polycrystalline separator. In at least one embodiment, the oxidizing agent, after contact with lithium metal, may form a product in the grain boundaries which is electrochemically stable against further lithium redox reactions. In a further embodiment, the oxidizing agent, after contact with lithium metal, may form an ionically conductive product in the grain boundaries. In some embodiments, the electronically insulating phase may have an electronic conductivity of less than 10⁻¹⁰ S/cm.

According to one or more embodiments, a solid-state battery includes a cathode; an anode including lithium metal; and an inorganic ceramic polycrystalline separator between the cathode and anode. The separator includes grains of an ionically conductive bulk phase and grain boundaries defined between the grains. The grain boundaries include an electronically insulating boundary phase to prevent electron conduction along the grain boundaries, and an ionically conductive phase to facilitate ionic conduction along the grain boundaries.

According to at least one embodiment, the electronically insulating boundary phase may be formed when lithium metal is brought into contact with an oxidizing agent via nucleation at, or dendritic growth of the lithium metal along the grain boundaries. In some embodiments, the ionically conductive phase may be a partially reduced phase of the oxidizing agent. In further embodiments, the oxidizing agent may be a binary metal oxide having the composition MO, MO₂, M₂O, or M₂O₃, where M is a metal, or a complex transition metal oxide. In certain embodiments, the oxidizing agent, after contact with lithium metal, may form a product in the grain boundaries which is electrochemically stable against further lithium redox reactions. In one or more embodiments, the ionically conductive bulk phase may be LLZO, NASICON having the formula NaM₂(P₄)₃, where M is a cation, Li₅La₃M₂O₁₂ where M is Ta or Nb, Li₃ₓLa_{2/3-x}TiO₃ (LLTO), a LiSICON (lithium super ionic conductor) having an ionic conductivity of 1.25×10⁻¹ S/cm at 300° C., or a LiPON. In at least one embodiment, the grain boundaries may be pores or voids within the inorganic ceramic polycrystalline electrolyte separator.

According to one or more embodiments, a method of preparing a solid-state battery includes providing a cathode, an anode including lithium metal, and an inorganic ceramic polycrystalline solid electrolyte separator between the cathode and anode, the separator including grains of an ionically conductive bulk phase and grain boundaries defined between the grains, the grain boundaries including an oxidizing agent. The method further includes oxidizing the lithium metal, brought into contact with the oxidizing agent via nucleation at, or dendritic growth of the lithium metal along the grain boundaries that results from plating of the lithium metal on the anode, and forming an electronically insulating phase to prevent electronic conduction along the grain boundaries; and further includes partially reducing the oxidizing agent upon contact with the lithium metal and forming an ionically conductive phase to facilitate ionic conduction along the grain boundaries.

According to at least one embodiment, the oxidizing agent may be a binary metal oxide having the composition MO, MO₂, M₂O, or M₂O₃, where M is a metal, or a complex transition metal oxide. In one or more embodiments, the ionically conductive bulk phase may be LLZO, NASICON having the formula NaM₂(PO₄)₃, where M is a cation, Li₅La₃M₂O₁₂ where M is Ta or Nb, Li₃ₓLa_{2/3-x}TiO₃ (LLTO), a LiSICON (lithium super ionic conductor) having an ionic conductivity of 1.25× 10⁻¹ S/cm at 300° C., or a LiPON. In certain embodiments, the ionically conductive phase and electronically insulating phase may be electrochemically stable against further lithium redox reactions. In one or more embodiments, the electronically insulating phase has an electronic conductivity of less than 10⁻¹⁰ S/cm. In certain embodiments, the grain boundaries may be pores or voids within the inorganic ceramic polycrystalline electrolyte separator.

### BRIEF DESCRIPTION OF THE DRAWINGS

FIGS. 1A-B are schematic illustrations of a conventional solid-state battery;

FIGS. 2A-B are schematic illustrations of a solid-state battery according to an embodiment; and

FIG. 3 is a schematic illustration of a reaction mechanism according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

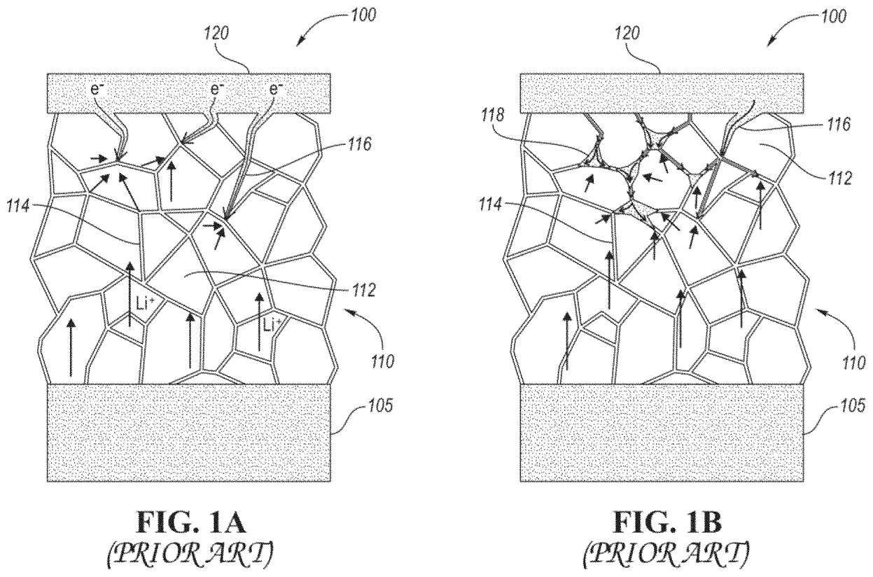

As shown in FIG. 1A, a conventional solid-state battery 100 includes a positive electrode (cathode) 105, a lithium metal negative electrode (anode) 120, and a solid-state electrolyte 110. A conventional solid-state electrolyte (SSE) 110 includes a bulk phase of grains 112 and grain boundaries 114 defined therebetween. Conduction across grain boundaries 114 may impede the ionic conduction through the bulk, and lithium metal from anode 120 may instead propagate along the grain boundaries 114 as shown by path 116. In SSEs, such as a lithium garnet like Li—La—Zr—O (LLZO), high electronic conductivity is typically responsible for dendrite formation within the bulk phase, rather than connected growth from the anode backward into the SSE. The appearance of Li metal deposits 118 as shown in FIG. 1B, within the grain boundaries of a shorted region of an SSE, suggests that the nucleation site of Li metal deposits 118 also resides within the grain boundary. As such, a mitigation approach of modifying grain boundaries may be more effective than approaches that are designed to impose physical barriers at the Li meta/SSE interface.

Further, the size of SSE grains within a dense solid typically effects the maximum current density sustained before a short circuit occurs. The SSEs with larger grains tend to have higher critical current densities, indicated by a lower susceptibility to dendrite growth. Because the grain boundaries form a continuous network across the SSE separator, a growth mechanism along grain boundaries should be sensitive to the grain size, as the total grain boundary interfacial area within a solid will scale with the inverse of the grain size, and therefore grow in importance relative to the conductivity through the grains themselves. If the grain boundaries are a significant focus of lithium ion conduction, then the mitigation of the propagation of the growth of Li metal deposits within the SSE should include a mitigation strategy that inhibits growth along grain boundaries.

Referring again to FIG. 1A-B, conventionally, a solid-state electrolyte 110 positioned against a Li metal anode 120 would be chosen from the subset of those examples that have an electrochemical window that would not be reactive with Li metal. Reactions at the anode interface may affect impedance, performance, and lifetime of the cell. However, choosing such a solid-state electrolyte that is compatible with Li metal does not necessarily prevent the formation and propagation of Li dendrites. As noted above, dendrites are known to grow along grain boundaries of dense solid electrolytes, such as LLZO, despite the fact that the shear modulus of LLZO is known to exceed the criterion described above for suppression of dendrites. If the grain boundaries conduct electrons sufficiently, reactions between an electron and a Li-ion may occur at the surfaces of a grain boundary anywhere within the bulk of the SSE. Over many cycles, isolated deposits of Li metal, such as deposits 118 in FIG. 1B, may grow and subsequently coalesce and form a dendrite. In this scenario, it may actually be the non-reactivity of LLZO with respect to the Li metal that facilitates the growth of Li metal dendrites along grain boundaries.

According to embodiments, a solid-state battery includes a cathode, an anode with lithium metal, and an inorganic ceramic polycrystalline separator. This separator is a solid-state electrolyte separator, including grains of a bulk phase, and modified grain boundaries between the grains. Ionic conduction can occur through grains in combination with conduction across grain boundaries or along the grain boundaries. The grain boundaries are modified with an oxidizing agent such that upon contact with a lithium metal deposit along the grain boundaries, reacts to oxidize the lithium metal and form an electronically insulative phase to prevent further electronic conduction along the grain boundaries. In at least one embodiment, the reaction product is an ionically conductive phase that facilitates ionic conduction along the grain boundaries. As such, the modified grain boundaries help suppress and control lithium metal dendrite propagation at the grain boundaries.

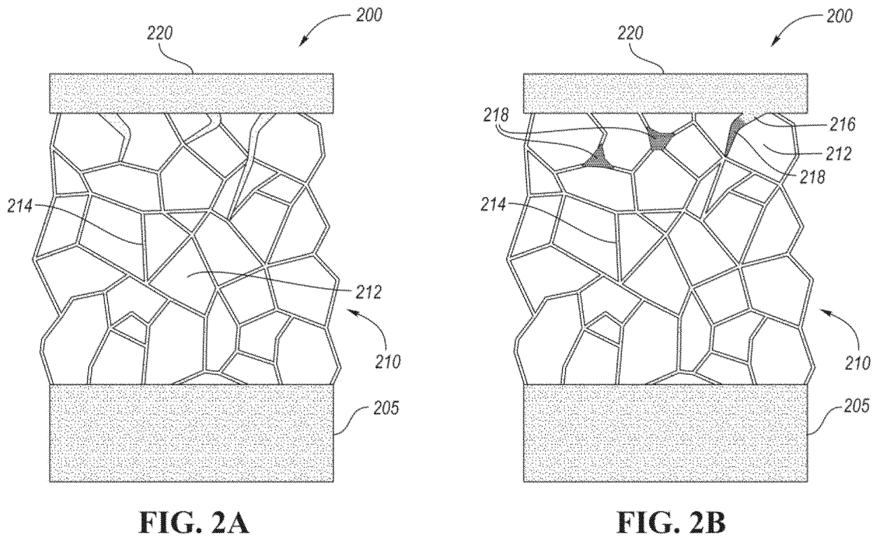

Referring to FIGS. 2A-B, a solid-state battery 200 is schematically shown. The solid-state battery 200 includes a cathode 205, a solid-state electrolyte (SSE) 210, and a lithium metal anode 220. The SSE 210 is a solid-electrolyte separator, and may be an inorganic ceramic separator, having a polycrystalline structure. In some embodiments, the SSE is a garnet-phase, such as LLZO or other suitable SSE. The SSE 210 includes grains 212 of a bulk phase, and grain boundaries 214 defined between the grains 212 of the bulk phase. Examples of the SSE 210 include, but are not limited to, sodium super ionic conductors (NaSICON) initiated from sodium super ion conductors with the formula NaM₂(PO₄)₃, where M is a cation, garnet with the composition Li₅La₃M₂O₁₂ (M=Ta, Nb), having lithium ionic conductivities in the magnitude of 10⁻⁶ S/cm at 25° C., perovskite having the formula Li₃ₓLa_{2/3-x}TiO₃(LLTO), having a bulk ionic conductivity of 10⁻³ Scm⁻¹ and total ionic conductivity of higher than 2×10⁻⁵ S/cm at room temperature for Li_{0.34}La_{0.51}TiO_{2.94}, a LiSICON (lithium super ionic conductor) with an ionic conductivity of 1.25×10⁻¹ S/cm at 300° C., or a LiPON (lithium phosphorus oxynitride). The bulk phase 212 and grain boundaries 214 generally have the same composition with the possibility of the formation of phase impurity at the grain boundaries.

The composition of grain boundaries 214 is chemically modified such that grain boundaries 214 include an additional component (or, interchangeably hereinafter, an oxidizing agent) selected to preferentially react with Li metal, and oxidize any Li metal that forms to prevent formation of highly conductive electron paths in the form of lithium dendrite 216, as shown in FIG. 2B, thus forming a reaction product phase 218 in the grain boundaries. The additional component is selected such that its reaction with Li metal 220 results in the reaction product phase 218 which is electronically insulating and, in some embodiments, ionically conducting. The additional component modifying grain boundaries 214 may be, but is not limited to, a binary metal oxide with nominal composition MO, MO₂, M₂O, or M₂O₃, where M represents metals (alkali, alkaline earth metals, lanthanides, transition metal, and post-transition metals); or a more complex transition metal oxide that has a tendency to be reduced upon contact with the Li metal anode. Other examples of the additional component that may be suitable include ionic conductors of the perovskite-type such as, but not limited to, Lithium Lanthanum Titanate (L₃ₓLa_{(2/3-x)}.(⅓−2x)TiO₃, LLTO), or a NaSICON type Li-ion conductor with a general formula of LiTi₂(PO₄)₃; Li₁₀GeP₂S₂, Li₇PS₅Cl, Li₇P₂S₈I, LiSICON, or Li_{3.25}Ge_{0.25}P_{0.75}S₄.

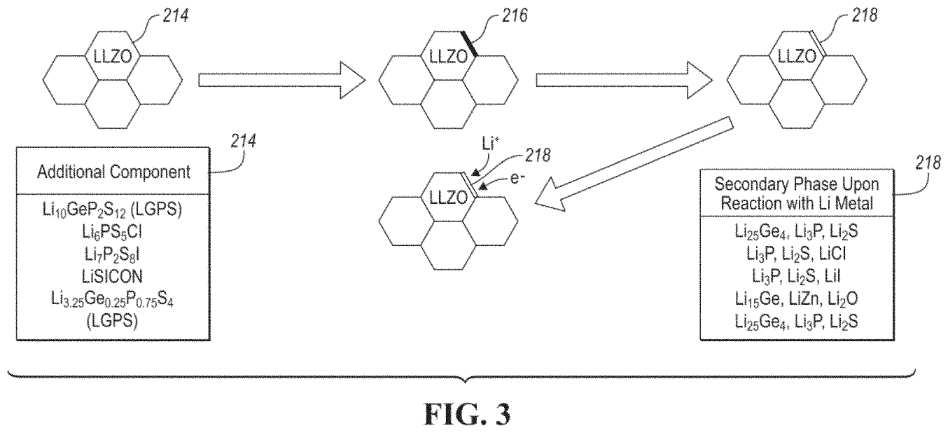

As such, upon reaction with the modified grain boundaries 214, the lithium metal 220 oxidizes to form a reaction product phase 218, which is an electronically insulating phase, as shown in FIG. 2B and schematically in FIG. 3. Modifying the grain boundaries 214 with an additional component that is selected to be reactive with Li metal addresses the growth of Li metal deposits 216 within dense solids. Because Li metal is easily oxidized to an electrically insulating phase 218, inducing a reaction between an advancing dendrite or an isolated Li metal deposit and the oxidizing agent limits the continued growth by limiting the supply of electrons. The final products of these reactions should be electrochemically stable against further redox reactions. The additional component may be a solid-state electrolyte that easily reacts with Li metal, and may also be an ionic conductor such that the impact of the reaction between Li metal and the oxidizing agent limits any negative impact on the ionic resistance of the SSE separator.

In some embodiments, the reaction product phase 218 is also an ionically conductive phase. This may be achieved by engineering the relative amount of the oxidizing phase such that the reaction leads to formation of a product phase with incomplete oxidation, providing structural defects that facilitate Li ion conduction. Other mechanisms of achieving ionic conduction in the product phase are possible and the description above is not intended to be limiting. In certain embodiments, the reaction product phase 218 formed may have an ionic conductivity less than the conductivity of the SSE composite. In this case, although the reaction product phase formed may result in some degradation of the overall ionic conduction of the SSE, the benefit of suppressing the dendrite propagation is likely greater than that of preserving the maximum ionic conductivity of the SSE. Thus, the reaction product phase 218 suppresses lithium metal dendrite growth and propagation along the grain boundaries. The additional component modifying the grain boundaries 214 may be selected such that the final products of the grain boundaries 214 is electrochemically stable against further Li+/Li redox reactions. Although an ionically conductive additive phase that is intrinsically reactive with Li metal is unsuitable for use as solid separator by itself, the use of the ionically conductive material as an additive phase in the grain boundaries takes advantage of both its ionic conductivity and it's reactivity with Li metal.

Referring again to FIG. 2, the grain boundaries are modified to include an additional component selected to preferentially react with Li metal dendrites and oxidize the Li metal such that dendritic growth along the grain boundaries is suppressed. In certain embodiments, the reaction product phase 218 of the lithium metal and the modified grain boundary is an electronically insulating phase. Furthermore, in certain embodiments, the reaction product phase 218 between the lithium metal and modified grain boundary also produces an ionically conducting phase. The reaction product phase has an electronic conductivity, in some embodiments, of less than 10⁻¹⁰ S/cm such that further growth of dendrites is inhibited. The electronic conductivity is suitably low enough such that the reaction product phase can endure the life of the cell. A schematic representation of the modified grain boundary 214 phases during operation is shown in FIG. 3, with non-limiting boundary phase examples of the additional component or oxidizing agent, the reaction product phase 218, and the electronically insulating phase.

As described above, the grain boundaries 214 can be modified by oxidizing agents. The oxidizing agent may be, in certain embodiments, binary metal oxides with nominal composition MO, MO₂, M₂O or M₂O₃, where M is a metal (alkali, alkaline earth metals, lanthanides, transition metal, and post-transition metals). The following are non-limiting examples of possible partial oxidation reactions between Li metal and various metal-oxide stoichiometry, where the metal oxide is partially reduced to form a metal, i.e. a metallic reaction product that would provide an electron path in the SSE:

TABLE 1

MO + yLi → MO₁₋ₓ + Li_{y}Oₓ
MO₂ + yLi → MO₂₋ₓ + Li_{y}Oₓ
M₂O + yLi → M₂O₁₋ₓ + Li_{y}Oₓ
M₂O₃ + yLi → M₂O₃₋ₓ + Li_{y}Oₓ

The additional component may be, in certain embodiments, a transition metal oxide. Certain transition metal ions adopt different formal oxidation states ranging from +2 to +5 for elements such as vanadium, and from +4 to +6 in the case elements such as molybdenum. Transition metal oxides may exhibit improved mechanical stability during SSE processing, and the metal oxide in its unreacted and reduced state, is an ionic conductor. Besides simple metal oxides, more complex transition metal oxides that are reduced upon contact with Li metal anode are contemplated in some embodiments. Some non-limiting examples that are also ionic conductors include the perovskite-type Lithium Lanthanum Titanate (LLTO)(Li₃ₓLa_{(2/3-x)}._{(1/3-2x)}TiO₃) which offers an ionic conductivity of >0.1 mS/cm, or the NaSICON type Li-ion conductor with a general formula of LiTi₂(PO₄)₃ with ionic conductivity of up to 0.4 mS/cm. Both of these compounds contain Ti, which go through a reduction from Ti⁴⁺ to Ti³⁺ upon contact with Li metal. Thus, the presence of these oxidizing agents will form a reaction product phase which suppresses propagation of Li metal in the microstructure of SSE.

The modification of grain boundaries can be completed during the SSE processing. For example, the oxidizing agent can be deposited on the surface of a preformed SSE powder using atomic layer deposition, chemical vapor deposition, physical or chemical vapor deposition, dip coating, or other suitable techniques prior to densification into a finished SSE separator. Thus, these oxidizing agents will modify the grain boundary prior to densification by sintering, hot pressing, tape casting, or other suitable processes. In some embodiments, a second oxidizing phase may spontaneously form at the grain boundaries based on the processing conditions and chemistry of the SSE. In other embodiments, a partially porous SSE may be infiltrated with the oxidizing agent.

According to embodiments, a solid-state battery includes a cathode, an anode with lithium metal, and an inorganic ceramic polycrystalline solid-electrolyte separator. The solid electrolyte separator includes grains of a bulk phase, and modified grain boundaries between the grains. The grain boundaries are modified with an additive phase, such as a oxidizing agent, such that upon contact with a lithium metal which has formed at a grain boundaries, the additive phase oxidizes the lithium metal to form an electronically insulative phase to prevent electronic conduction along the grain boundaries. Further, the oxidizing agent may be a partially reduced phase that is an ionically conductive phase to facilitate ionic conduction along the grain boundaries. The modified grain boundaries help suppress and control lithium metal formation and dendrite propagation at the grain boundaries.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A solid-state battery comprising:
a cathode;
an anode including lithium metal; and
an inorganic ceramic polycrystalline separator between the cathode and anode, the separator including grains of an ionically conductive bulk phase and grain boundaries defined between the grains, the grain boundaries including an oxidizing agent configured to
oxidize the lithium metal, brought into contact with the oxidizing agent via lithium metal nucleation at or dendritic growth along the grain boundaries that results from plating of the lithium metal on the anode, to form an electronically insulating phase to prevent formation of electronic conduction pathways along the grain boundaries, and
partially reduce, upon oxidation of the lithium metal, to form an ionically conductive phase to facilitate ionic conduction along the grain boundaries.

2. The solid-state battery of claim 1, wherein the oxidizing agent is a binary metal oxide with the composition MO, MO₂, M₂O, or M₂O₃, where M is a metal, or a complex transition metal oxide.

3. The solid-state battery of claim 1, wherein the ionically conductive bulk phase is LLZO, NASICON with formula NaM₂(PO₄)₃, where M is a cation, Li₅La₃M₂O₁₂ where M is Ta or Nb, Li₃ₓLa_{2/3-x}TiO₃(LLTO), a LiSICON (lithium super ionic conductor) having an ionic conductivity of 1.25×10⁻¹ S/cm at 300° C., or a UPON.

4. The solid-state battery of claim 1, wherein the grain boundaries are pores or voids within the inorganic ceramic polycrystalline separator.

5. The solid-state battery of claim 1, wherein the oxidizing agent, after contact with lithium metal, forms a product in the grain boundaries which is electrochemically stable against further lithium redox reactions.

6. The solid-state battery of claim 1, wherein the oxidizing agent, after contact with lithium metal, forms an ionically conductive product in the grain boundaries.

7. The solid-state battery of claim 1, wherein the electronically insulating phase has an electronic conductivity of less than 10⁻¹⁰ S/cm.

8. A solid-state battery comprising:
a cathode;
an anode including lithium metal; and
an inorganic ceramic polycrystalline separator between the cathode and anode, the separator including grains of an ionically conductive bulk phase and grain boundaries defined between the grains, the grain boundaries including an electronically insulating boundary phase to prevent electron conduction along the grain boundaries, and an ionically conductive phase to facilitate ionic conduction along the grain boundaries.

9. The solid-state battery of claim 8, wherein the electronically insulating boundary phase is formed when lithium metal is brought into contact with an oxidizing agent via nucleation at, or dendritic growth of the lithium metal along the grain boundaries.

10. The solid-state battery of claim 9, wherein the ionically conductive phase is a partially reduced phase of the oxidizing agent.

11. The solid-state battery of claim 9, wherein the oxidizing agent is a binary metal oxide with the composition MO, MO₂, M₂O, or M₂O₃, where M is a metal, or a complex transition metal oxide.

12. The solid-state battery of claim 9, herein the oxidizing agent, after contact with lithium metal, forms a product in the grain boundaries which is electrochemically stable against further lithium redox reactions.

13. The solid-state battery of claim 8, wherein the ionically conductive bulk phase is LLZO, NASICON with formula NaM₂(PO₄)₃, where M is a cation, Li₅La₃M₂O₁₂ where M is Ta or Nb, Li₃ₓLa_{2/3-x}TiO₃(LLTO), a LiSICON (lithium super ionic conductor) having an ionic conductivity of 1.25×10⁻¹ S/cm at 300° C., or a LiPON.

14. The solid-state battery of claim 8, wherein the grain boundaries are pores or voids within the inorganic ceramic polycrystalline separator.

15. A method of preparing a solid-state battery comprising:
providing a cathode, an anode including lithium metal, and an inorganic ceramic polycrystalline solid electrolyte separator between the cathode and anode, the separator including grains of an ionically conductive bulk phase and grain boundaries defined between the grains, the grain boundaries including an oxidizing agent;
oxidizing the lithium metal, brought into contact with the oxidizing agent via nucleation at, or dendritic growth of the lithium metal along the grain boundaries that results from plating of the lithium metal on the anode, and forming an electronically insulating phase to prevent electronic conduction along the grain boundaries; and
partially reducing the oxidizing agent upon contact with the lithium metal and forming an ionically conductive phase to facilitate ionic conduction along the grain boundaries.

16. The method of claim 15, wherein the oxidizing agent is a binary metal oxide with the composition MO, MO₂, M₂O, or M₂O₃, where M is a metal, or a complex transition metal oxide.

17. The method of claim 15, wherein the ionically conductive bulk phase is LLZO, NASICON with formula NaM₂(PO₄)₃, where M is a cation, Li₅La₃M₂O₁₂ where M is Ta or Nb, Li₃ₓLa_{2/3-x}TiO₃(LLTO), a LiSICON (lithium super ionic conductor) having an ionic conductivity of 1.25×10⁻¹ S/cm at 300° C., or a LiPON.

18. The method of claim 15, wherein the ionically conductive phase and electronically insulating phase are electrochemically stable against further lithium redox reactions.

19. The method of claim 15, wherein the electronically insulating phase has an electronic conductivity of less than 10⁻¹⁰ S/cm.

20. The method of claim 15, wherein the grain boundaries are pores or voids within the inorganic ceramic polycrystalline electrolyte separator.
